(19) United States
(12) Patent Application Publication
(10) Pub. No.: US 2003/0115546 A1
(43) Pub. Date: Jun. 19, 2003

(54) Method and apparatus for integrating digital media assets into documents

(76) Inventors: Stuart P. Dubey, San Rafael, CA (US); Jeff A. Lipton, Berkeley, CA (US)

Correspondence Address: Patent Department, Attn Timothy W Lohse, Gray Care Ware & Freidenrich LLP, 1755 Embarcadero Road, Palo Alto, CA, 94303, US

(21) Appl. No.: 09/788,064

(22) Filed: Feb. 16, 2001

Related U.S. Application Data
(60) Provisional application No. 60/183,500, filed on Feb. 17, 2000.

(51) Int. Cl. G06F 15/00

(52) U.S. Cl. 715/501.1

(57) ABSTRACT

A method and apparatus for adding one or more sounds to a document is described. In one embodiment, the method comprises specifying a sound element to be played during user navigation of the document, identifying a location in the document to trigger playing the sound element, and linking the sound element to the document to allow the sound element to be played during user navigation of the document.

This application claims the benefit of U.S. Provisional Application No. 60,183,500 entitled “A Method and Apparatus for Providing Sonification of Web Documents, Accessed or Transmitted over Computer Networks,” filed Feb. 17, 2000.

### FIELD OF THE INVENTION

The present invention relates to the field of associating sound elements with documents; more particularly, the present invention relates to linking digital assets with electronic documents.

### BACKGROUND OF THE INVENTION

An important use of computers is the transfer of information over a network. Currently, the largest computer network in existence is the Internet. The Internet is a worldwide interconnection of computer networks that communicate using a common protocol. Millions of computers, from low end personal computers to high-end super computers are coupled to the Internet.

In 1989, a new type of information system known as the World-Wide Web (“the Web”) was introduced to the Internet. Early development of the Web took place at CERN, the European Particle Physics Laboratory. The Web is a wide-area hypermedia information retrieval system aimed to give wide access to a large universe of documents.

The architecture of the Web follows a conventional client-server model. The terms “client” and “server” are used to refer to a computer's general role as a requester of data (the client) or provider of data (the server). Under the Web environment, Web browsers reside in clients and Web documents reside in servers. Web clients and Web servers communicate using a protocol called “Hypertext Transfer Protocol” (HTTP). A browser opens a connection to a server and initiates a request for a document. The server delivers the requested document, typically in the form of a text document coded in a standard Hypertext Markup Language (HTML) format, and when the connection is closed in the above interaction, the server serves a passive role, i.e., it accepts commands from the client and cannot request the client to perform any action.

Portions of documents displayed on the Web contain hypertext links. The hypertext links link graphics or text on one document with another document on the Web. Each hypertext link is associated with a Universal Resource Locator (URL) that identifies and locates a document on the Web. When a user selects a hypertext link, using, for instance, a cursor, the graphical browser retrieves the corresponding document(s) using a URL(s).

There are a number of technologies that exist today to create and distribute sound over the World Wide Web. For Web pages in HTML, an EMBED command may be used to embed an audio file into an HTML document. When this is used, the audio file may only be played when the web page is loaded. Therefore, the EMBED command does not allow an individual to set up a web page so that an audio file plays at times other than when the page is loaded, such as when a user performs a particular action. Furthermore, the EMBED command does not allow the user to stop the playback of the audio file. Thus, using the EMBED command doesn't provide the flexibility of truly user controlled, interactive audio.

### SUMMARY OF THE INVENTION

A method and apparatus for adding one or more sounds to a document is described. In one embodiment, the method comprises specifying a sound element to be played during user navigation of the document, identifying a location in the document to trigger playing the sound element, and linking the sound element to the document to allow the sound element to be played during user navigation of the document.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of the process for performing sonification with a graphical user interface.

FIG. 2 is a block diagram of one embodiment of a network illustrating interaction between clients and servers in performing a sonification process.

FIG. 3 is a flow diagram illustrating one embodiment of the sonification process.

FIG. 4 illustrates a screen shot of an exemplary web page providing a directory of sounds from which a user may audition and/or collect.

FIG. 5 illustrates a screen shot of an exemplary dialog box to specify a document identifier (e.g., a universal resource locator) of a document that is to be modified to have one or more sound elements linked thereto.

FIG. 6 illustrates an exemplary web page that is being sonified.

FIG. 7 is a block diagram of one embodiment of a network environment.

FIG. 8 is a block diagram of an exemplary computer system.

### DETAILED DESCRIPTION

A method and apparatus for integrating digital media files (including, but not limited to, sounds, images, moving pictures, 3d objects, either static or animated, interactive or not, further referred to as “digital assets”) into web documents and particularly for providing sonification of web documents, accessed or transmitted over computer networks are described.

In one embodiment, the integration of digital media files comprises specifying a sound element to be played during user navigation of the document, identifying a location in the document to trigger playing the sound element, and linking the sound element to the document to allow the sound element to be played during user navigation of the document.

In the following description, numerous details are set forth to provide a thorough understanding of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

A method and apparatus for providing integration of “digital assets” and particularly for sonification of web documents, accessed or transmitted over computer networks. In one embodiment, the “digital assets” are encoded into or bound with new or existing web documents through a Web-based application, referred to herein as the WM application, and then published back to the user. The version published back to the user may be in an immutable rendition.

In one embodiment, an Internet-based process for editing web documents is provided. The process is performed by processing logic that may comprise hardware (e.g., dedicated logic, circuitry, etc.), software (such as is run on a general purpose computer system or a dedicated machine), or a combination of both.

The process comprises a user accessing WM application program via the Internet, loading a web document into the window of a browser, and performing operations to bind sound elements or media files to that web document. The sound elements or media files are bound to the document by inserting a routine or script into the document. This is particularly easy with documents such as HTML documents. In such a case, the routine may comprise a link to the digital asset, which when triggered to play, causes a request to be sent to a server where the digital asset is maintained (or from which it can be accessed). In response to the request, the server provides the digital asset to the browser and the browser plays the digital asset.

In one embodiment, the user can specify what interactive action (e.g., mouse click, key press, moving a cursor over a location in the document, etc.) triggers the sound or media file to play and can then preview the results immediately.

In one embodiment, providing access to sounds and providing the software to enable sonification may generate a revenue stream to its operator through a fee for service basis, a monthly subscription service basis, advertising banners in conjunction with corporate sponsorships and promotions, or through licensing agreements with Internet service providers, Website hosting companies, Internet community portals, or other business entities.

In one embodiment, the WM application comprises a cross platform/cross browser format web-based software tool to facilitate easy sonification of web sites or any other web-based document. The WM application may provide a drag-and-drop interface that allows users to integrate clip-art style sound libraries into their web pages. This type of integration may be useful, among other uses, for integrating sound into backgrounds or for layering multiple versions of sounds. Pop-up menus allow users to select from a range of interaction criteria (e.g., mouse click, positioning a curser over an object (mouse over), key selection, etc.). The application allows for instantaneous preview of site functionality.

Collecting Sounds

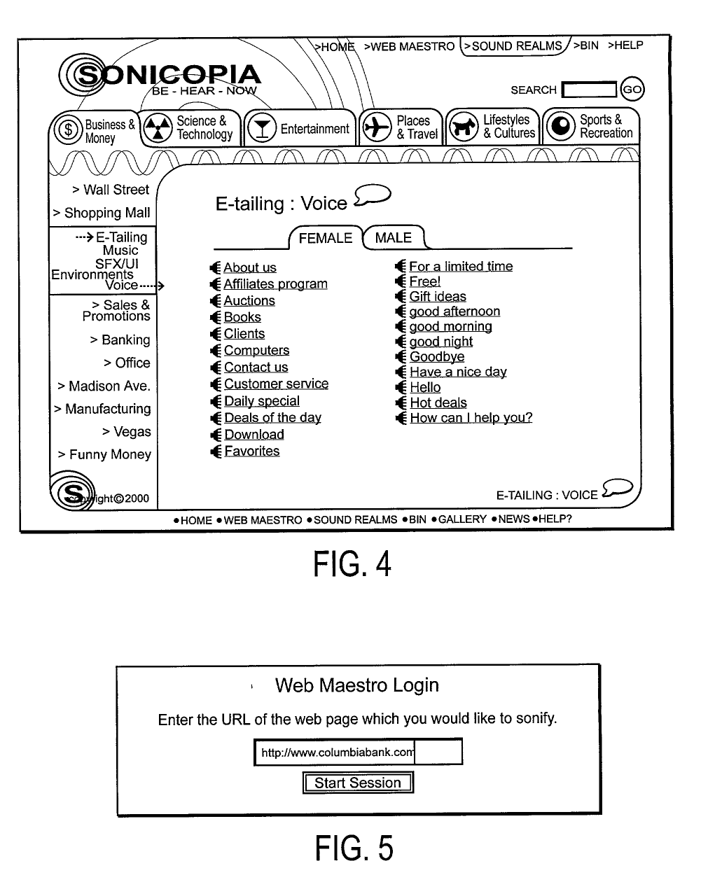

The user may be given access to a number of sounds (including music) through an interface. FIG. 4 illustrates an exemplary web page that offers such an interface. The interface may permit the user to audition sounds. The interface may organize the sounds for easy of access. For example, the sounds may be organized based on themes. In one embodiment, the user has the option to audition sounds and music through a keyword-based search engine, browse through theme-based sound sets, or navigate theme-based graphical representations (these theme-based graphical environments are accompanied by associated music and sounds).

In one embodiment, the interface, such as shown in FIG. 4, includes a web page that includes a search entry field and a search icon that causes the search engine to perform a search based on what was entered in the search entry field. For example, to search for sounds by keyword, a user may enter ‘dog’ into the search entry field and then select the ‘search’ icon. Then a database (preferably located or accessible via a server) returns the description of any sound that used ‘dog’ in the title or description (the sound of a dog barking or a piece of music named ‘Dog House Rock’). In one embodiment, two additional icons are included to facilitate auditioning and selection of sounds. For example, the user may audition a returned sound file by clicking a cursor control device (e.g., mouse, trackpad, keyboard, etc.) on a ‘play’ icon or collect the sound by clicking on the ‘add’ icon to add the sound file to their ‘sound bin’ or virtual shopping cart.

An example of browsing through themed-based sound sets might be a collection of business sounds for use on an e-commerce website. In one embodiment, the user is presented with a page that contained several pieces of music, related musical stings or audio logos, user interface sounds, sound effects, and audio ambiences or sonic environments. As with the search process, the user may audition or collect the themed-based sounds by selecting the appropriate ‘play’ or ‘add’ icon.

An example of a graphical theme-based domain might be a Caribbean island in which the user is presented with an image of a beach with palm trees and a small cabana hut. When the page loads, the sound of ocean surf begins to play along with a subtle Caribbean calypso song. The user explores this domain with their cursor control device, and when the device cursor changes, a sound event has been discovered. If the device is clicked on this object, the associated sound starts playing. The user can then double click on the same area to add that sound to a ‘sound bin’. The user can continue to browse through different domains, adding multiple sounds to their ‘sound bin’.

In one embodiment, after selecting the sounds they want to use for sonifying their web page, the user clicks on a link to the WM application on a sound collection page. This link takes the user to the WM application login page. Once logged in, the activity of sonification may begin.

Application Flow

In one embodiment, the WM application is split between a server-side application created with Java, PERL, Python, C, C++, or any appropriate programming language (the “Server Application”), and a client-side Graphical User Interface (GUI) created with Javascript, DHTML, Flash, Java, or any appropriate programming language (the “Editor”).

The following discussion is focused on binding or linking a sound element into an electronic document, such as, for example, a web page. It should be understood that the teachings of the present invention may be used to integrate any type of digital asset into a document.

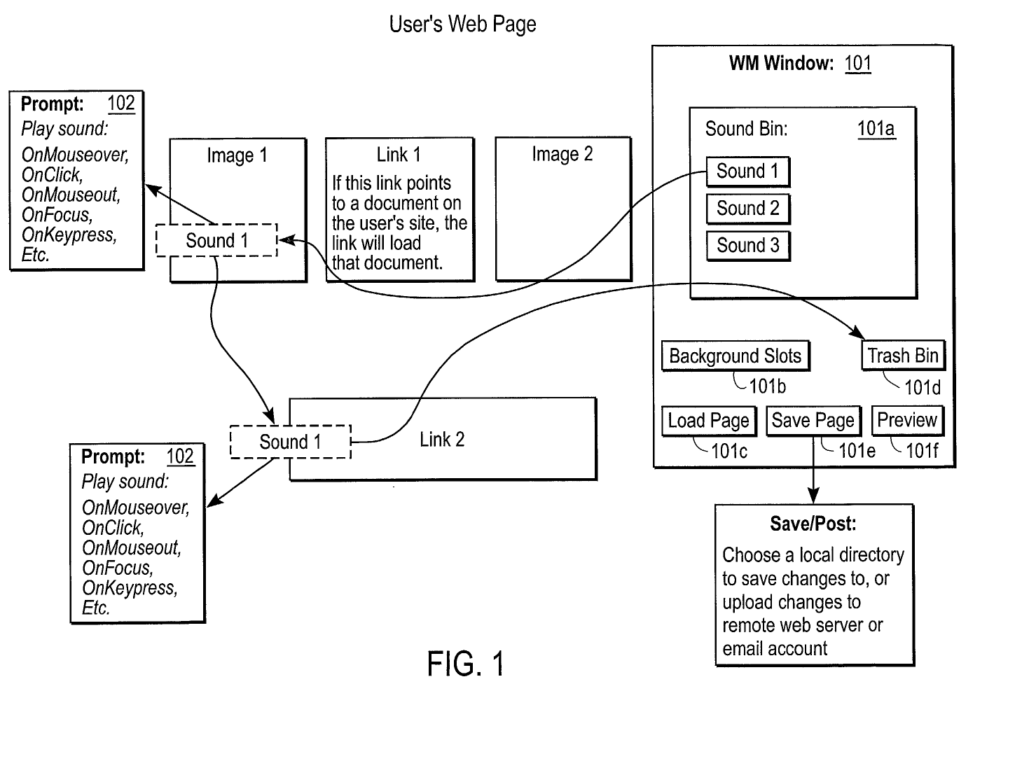

FIG. 1 illustrates one embodiment of the process for performing sonification with a graphical user interface. The process is performed by processing logic that may comprise hardware, software or a combination of both.

Referring to FIG. 1, a web page the user wishes to sonify is displayed on their browser with a control panel, referred to as WM window 101. The web page includes a number of images (e.g., image 1, image 2, etc.) and a number of links (e.g., link 1, link 2, etc.). The web page may be loaded in response to selecting the load page control button 101C.

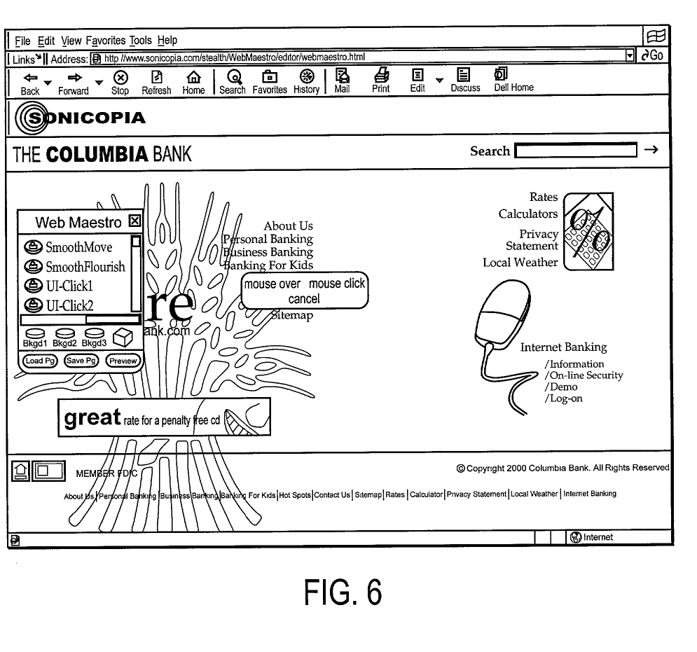

Once the web page is loaded and displays WM window 101, a user using a drag-and-drop interface may drag-and-drop sound icons, such as sound 1, sound 2, and sound 3, from sound bin 101A onto objects on the web page such as, for example, images and links. For example, as shown in FIG. 1, sound 1 is dragged and dropped on top of image 1. When this occurs, a dialog box, or prompt window, such as prompt window 102 is displayed requesting the user to specify the trigger action to cause sound 1 to be played. In one embodiment, the user can specify that a sound is to be played in response to a mouse (or cursor) over event, a mouse click event, tabbing to another field (e.g., the next field), a keyboard keypress event, loading a document, unlading a document, or any other well-known mechanism that allows user events to be monitored by a web browser (e.g., Javascript). FIG. 6 illustrates an exemplary web page that is being sonified.

In one embodiment, the user can remove sounds from a web page. For example, in FIG. 1, sound 1 is removed by clicking on sound 1 in the document and dragging it to trash bin 101D.

In one embodiment, a user may also specify sounds to play when the web page is loaded. This may be done by depositing sound icons in the background slots 101B, which indicates one or more slots for specifying background sounds to play. Once the sound icon(s) has been inserted into the background slot, the sound(s) play when the page is loaded in a manner well-known in the art.

In one embodiment, after inserting one or more sounds in a document, the user may preview the document by selecting the preview control button 101F. In response to pressing preview button 101F, the WM application displays the document without control panel 101 and the user may interact with the document, thereby triggering the presentation of the digital asset.

When the user has completed insertion of one or more sounds in a document, the user may save or post the document by selecting save page control button 101E. In response to selecting the save page control button 101E, the user may choose a local directory into which to save changes or upload changes to a remote web server or electronic mail (email) account.

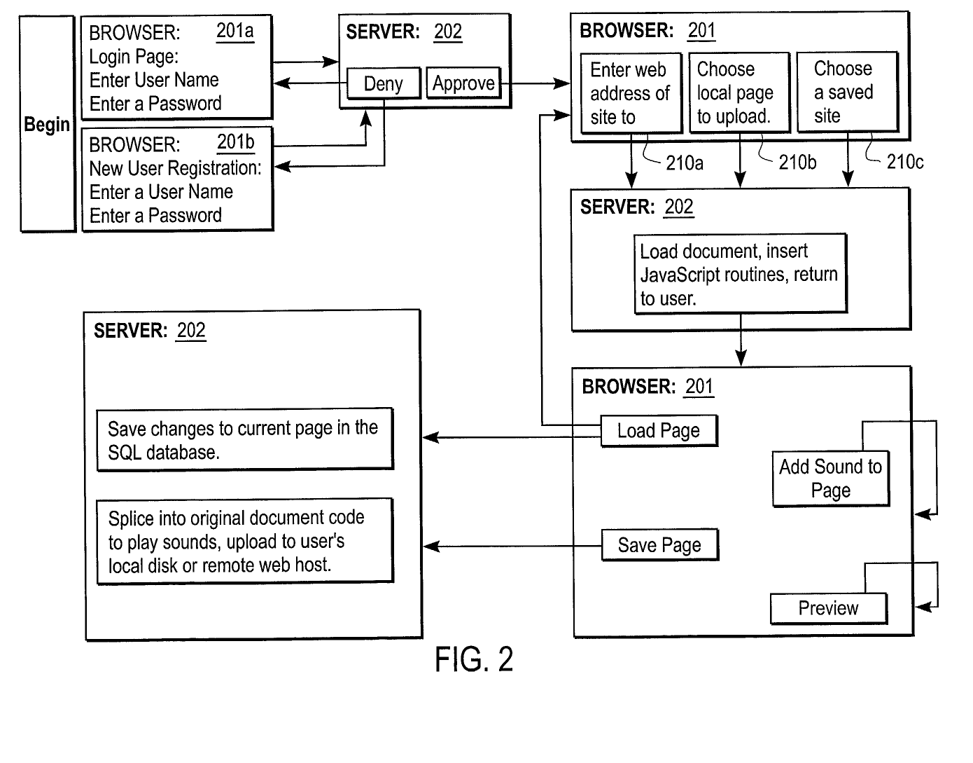

FIG. 2 is a block diagram of one embodiment of a network illustrating interaction between clients and servers in performing a sonification process. The processing is performed by processing logic that may comprise hardware, software or a combination of both.

Referring to FIG. 2, the process begins with a user, from their browser, engaging with a server. More specifically, a user, in conjunction with browser 201A logs-in to gain access to the WM application and the sonification service via server 202. The login procedure may include entering a user name and password on a login page. Alternatively, a user, in conjunction with browser 201B registers with server 202 as a new user. This registration process may include entering a user name and password, along with other relevant personal information, on a new user registration page.

In response to user login or registration, server 202 either grants or denies access. If server 202 denies access, server 202 sends an indication of the denial to browser 201. If server 202 grants access, then the user is allowed to use the WM application and the sonification service.

Once granted access, the user specifies a document into which a sound is going to be integrated. For example, the user may enter a web address of a site (210A), choose a local page to upload (210B), or choose a saved site from a previous sonification session (210C). The selection is sent to server 202, which loads the document, inserts routines to load the control panel (e.g., WM application window 101), and returns the document to the user. In one embodiment, the routines are JavaScript routines.

At this point, the user may load a new page with the control panel appearing on top of the page, may add one or more sounds to the page, preview the page, or save the page, as discussed before with respect to FIG. 1. If the user loads a new page with browser 201, server 202 saves the changes to the current page. In one embodiment, server 202 saves the changes to the current page into a SQL database. If the user selects the save control button with browser 201, server 202 splices the original document to insert code to play any sounds added and uploads the newly modified document to the user's local disk or remote web host.

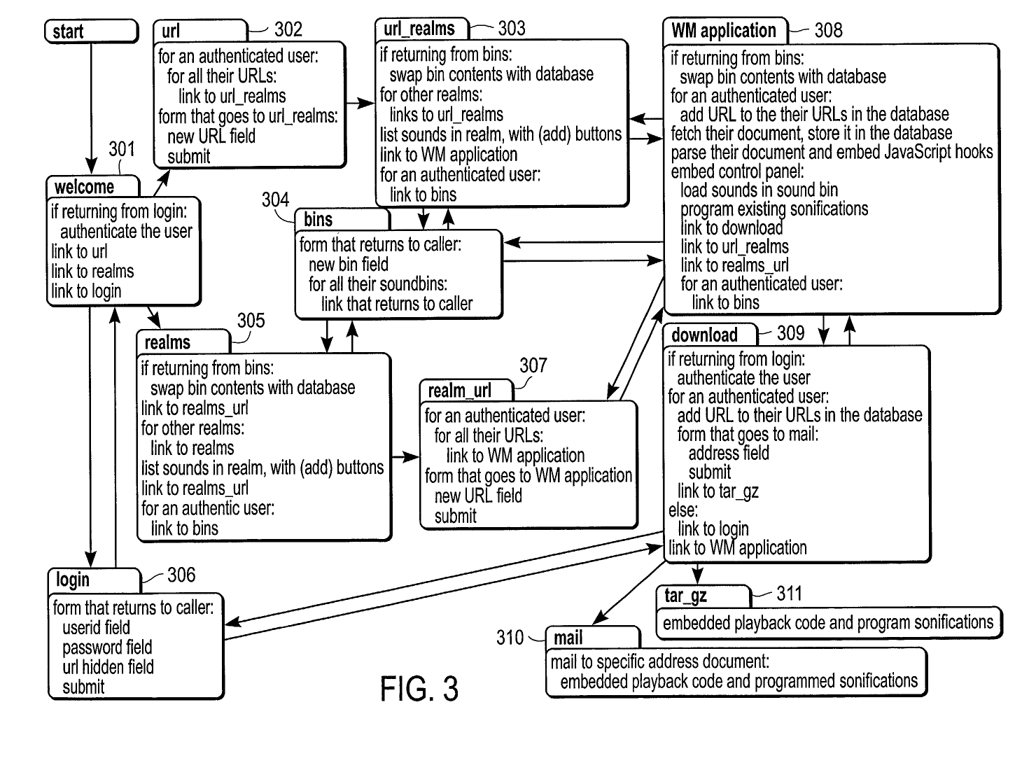

FIG. 3 is a flow diagram illustrating one embodiment of the sonification process. The psuedo code set forth in FIG. 3 would be well understood by those skilled in the art. Referring to FIG. 3, the process begins with a welcome page 301 that includes links to a URL page, a sound audition and selection page, referred to herein as realms or sound realms, and a link to a login page.

Selection of the URL link transitions a user to a URL page 302 where the user may enter a URL. Upon entry of a URL, processing transitions to URL_realm page 303 from which the user may gain access to the sound realm where sounds may be auditioned and collected, via bins 304, or access to the WM application 308, where the user may sonify their documents.

Selection of the realms link transitions a user to realms page 305 where the user may audition and collect sounds, via bins 304. From realms page 305, the user may transition to bins 304 to collect sounds or to the WM application 308, via realms_URL 306.

Selection of the login link, transitions processing to login page 306 that enables a user to enter login information into a login page. Once logged in, the user may transition to URL page 302, sound realms page 305 or download 309. From download 309, the user may access WM application 308.

WM application 308 allows sounds to be integrated into documents and then downloaded, via download 309, to a user's designated web host in the form of embedded playback code and program sonification via 311 or to a user designated email account in the form of embedded playback code and program sonification via 310.

Loading a Site

As discussed above, the application flow begins by loading a site. In one embodiment, the user is prompted to enter the URL address of the web document that they would like to sonify, or they may browse their local disk for a document to upload. If the user has saved documents from a previous WM session, they may also be displayed as choices. When a selection has been made, a server application retrieves the requested document, makes a copy of the page and inserts the appropriate script libraries required to run the WM application, and returns the updated page to the user.

Navigating the Site

After loading the requested web document, the application allows for navigating the site. The WM application is now running. In one embodiment, the WM application uses dynamically positioned elements to create a hovering control panel window above the loaded document. The dynamically positioned layered element may comprise a DHTML layered element; however, this is not a requirement. In alternative embodiments, Flash or Java may be used to obtain the same effect.

In one embodiment, when the server application makes a copy of the requested HTML document, it also creates a list of documents that are related, or linked to, the original requested document. The user can then navigate through their site by choosing any site document from a ‘load’ list on the dynamically positioned control panel window, or by clicking through a link to another page within the site. When the user requests a new, related document, the server application performs the same parsing and script library insertion as with the original page.

In one embodiment, the database containing user information and saved work is managed through a customized database API (Application Programming Interface) in a manner well-known in the art.

Adding Sounds

While navigating the site, a user may integrate digital media assets into the web document. In one embodiment, within the WM application control panel is a scrollable ‘sound bin’ that contains all sound file references collected from the user's sound browsing session. To listen to a sound in the ‘sound bin’, the user can click on the sound to audition it. Sounds can be dragged from this bin and placed over objects within the user's document. In one embodiment, a unique icon represents each sound instance. When the mouse button is released over an element, a dialog prompt appears, offering the user a choice of events to trigger the sound. When a trigger event is chosen, the element is instantly sonified. The dropped sound now plays every time the chosen trigger event occurs.

Once a sound has been deployed, it can be un-applied and re-applied to another element by using the same drag-and-drop paradigm. If the sound is dropped in a clear space free of any document objects, it will be inactive. To remove a sound entirely, the icon can be dropped into a trash bin on the control panel.

Scrolling of the sound bin may be accomplished with dynamic layer manipulation, which is well-known in the art.

In one embodiment, within the WM application control panel, located below the sound bin, are several slots designated for background sounds. A background sound is a sound that begins playing when the page is initially loaded and is not associated with any other user action. At any time, the user may assign sounds from the sound bin into these slots to add background sounds or music to their document. When a slot is occupied, a sound instance icon rests within it. To remove a background sound from a slot, the user can either drag the sound icon into the document or into the trash.

In one embodiment, at any time in their session, the user may enter a preview mode in which all graphic icons and the WM application control panel are hidden. In preview mode, hyperlinks become active and the sonified document now appear as it would after it has been posted back to the user's host server. A small tab resides in the corner of the screen to exit the preview mode.

Objects within a web document that can be sonified include, but are not limited to: image areas, links, form elements, text blocks, titles, animations, and embedded objects.

In one embodiment, the WM application is a HTML/javascript editor with the ability to insert code into a web document, thereby giving it flexibility to address different file types and act as a web site building tool. In alternative embodiments, the tool may be used to integrate many different media types (images, downloadable movies, streaming movies, animated files (flash movies), 3d objects or movies, text, etc.) into a web document. How these different media types would be addressed by the user depends on the type of media that has been integrated. Web browsers have the ability to respond to a wide variety of user actions (mouse clicks, mouse moves, keyboard strokes, page loads, etc.). These user actions can then be used to trigger media in different ways. In the case of a movie file, the user might start the movie playing by clicking on the embedded movie screen within the web page and then control rewind and fast forward features using the arrow keys on the keyboard. Similarly, the user might mouseover the movie to begin playback and mouseoff the movie to stop playback. In the case of integrating image files, user actions would not necessarily have an effect on the image following integration (although image swapping techniques are commonly used in current web page development).

The extent of what functions can be controlled are dictated by the features of the specific media technology. User events are captured by the browser and then translated into instructions for the media file to perform a certain function. This approach makes the WM application very useful beyond audio integration and it is also extensible to accommodate different coding or scripting languages as well as all current or any future media technologies.

Saving and Posting Changes

After adding sounds or other media files, changes may be saved or posted. In one embodiment, the user may upload their changes back to any host server through an ftp (file transfer protocol) utility, download the modified pages to local memory (e.g., their local disk), or have the sonified document sent to their email account.

Upon receiving the save request from the user, the server application loads the original document, adds to it any necessary sonification file reference code for the changes to be functional, and sends the updated document to its correct destination. In one embodiment, cookies are used to store all editor states prior to user registration, the use of which is well documented.

Code refers to any scripted or pre-compiled set of instructions used in addressing a given media format within a web document. All code is independent of the functionality of the WM application, and therefore, does not require the WM application for its execution.

The Server Application

Session Tracking

In one embodiment, each time a user logs into the WM application, a unique key is generated and maintained for the duration of their session. As they sonify a web site and make requests back to the server application, this key serves as their verification. In such a case, without a valid session key, the WM application is inaccessible.

In one embodiment, session keys are integrated into an application session tracking API in a manner well known in the art.

Network Communication

In one embodiment, to retrieve a new page for display in the editor, the server application opens its own connection to the specified host, retrieves the contents of the web document, and converts the raw data to text and images. When the user requests to post the modified pages back to their host server, the server application opens a connection to the specified host and transfers all the modified pages to the chosen directory.

In one embodiment, communication is done through the server networking API using protocols such as, for example, HTTP, ftp, or email, in a manner well-known in the art.

Pattern Matching and Extraction

In one embodiment, insertion of the WM application into a user's web document is done through Regular Expression Pattern Matching. The document is searched, and when the correct location for script code is found, the WM application routines are spliced in, preserving existing functionality whenever possible.

When the sonification of a document is complete, the server application again uses regular expressions to splice in all required code changes. It searches the original document for all elements that have been sonified and appends the appropriate code to each one in order to play the associated sound on the desired event. In one embodiment, the appropriate code comprises a link, which causes a request to server to be made to obtain the sound when the trigger event occurs.

Regular expressions and pattern matching are well known in the art.

The Client Side GUI

Dynamic Layering

Among other features, a method of recycling destroyed sound layers is provided. In one embodiment, when a sound is pulled from the sound bin and a new sound instance is created, a check is first made to determine if any sounds have been previously placed in the trash. If so, the layer from the trashed sound is recycled and used for the new sound instance. If no trashed sounds are present, then a new layer is created.

Drag-and-Drop

In one embodiment, the drag-and-drop features of the WM application centers around three separate mouse or device pointer events: the mouse down to select the drag object, the mouse movement to move the drag object, and the mouse up to release the drag object. To create the successful drag and drop within the WM application, the default handlers for these three events are rewritten. The mouse down first marks which layer to drag. The mouse move then changes the position of the newly marked layer to the coordinates of the mouse cursor. Finally, the mouse up un-marks the layer to cease the dragging.

The x,y coordinates of the location of the mouse up are recorded and used to correlate to the x,y coordinates of the object at that location so that the proper insertion of the embedded playback code can occur. That is, once the mouse up event occurs, the coordinates of the location of the mouse are recorded and used to determine what object in the document was at that location. Once the object in the document has been identified, the playback code may be appended to the object code when the document is saved back to the server. Drag-and-drop methodology is well-known in the art.

Real-Time Playback

In one embodiment, to track which elements have been sonified, the WM application makes use of each element's ID property. During the initial document load, the ID for each element is over-written with a new unique identifier. The WM application uses this new ID to correlate the document objects with the sounds. When an object is sonified, a sound and a trigger event are appended to the end of the new ID. Each time that event occurs on that object, the ID property is checked and if the event is present, the sound is played. If a sound is removed, the event and sound are removed from the ID property.

For version 4.X of Navigator, not all elements carry an ID property. In one embodiment, for links, the Search property of the link's URL is used instead, and for images the Name property is used.

The reading and writing of an element's properties is well known in the art.

Exemplary Application Features

The following is a list of features that may be included in various embodiments:

Drag and drop editing environment.

Interface with a pool of sounds using a sound bin.

Supports downloading of online documents or uploading of local documents.

Supports real-time audition of sounds within an editing environment.

Supports full window preview that hides all the program windows and icons.

Supports various event types (e.g., keyboard events, mouse events, window events, etc).

Supports user-defined sounds referenced through external URL's.

Supports standard digital audio and midi formats.

Supports drag-and-drop editing of various types of web media (e.g., images, animation, 3d, etc).

Supports scripting of HTML, JavaScript, XML, DHTML, XHTML, WML, PulseScript, and any other current or future scripting language used for the display of web documents.

Supports secure upload of sonified documents back to user's home server, save to local hard disk, or email of sonified document.

Supports the ability for users to record their own voice or music from their personal computer and upload the resulting audio files to the WM application server for sonification to their web page.

Revenue Streams

Revenue streams can be generated by the WM application in a number of ways. For example, advertising banners and media can be displayed in the WM application. Also, use of the WM application can be charged on a pay per use basis, fee for service basis, or on a subscription term basis or can be licensed to Internet service providers, web hosting companies, and web-based home site communities. Such licensing arrangements can also include revenue sharing and transaction sharing fees for associated pages that include the WM application technology.

An Exemplary Network Environment

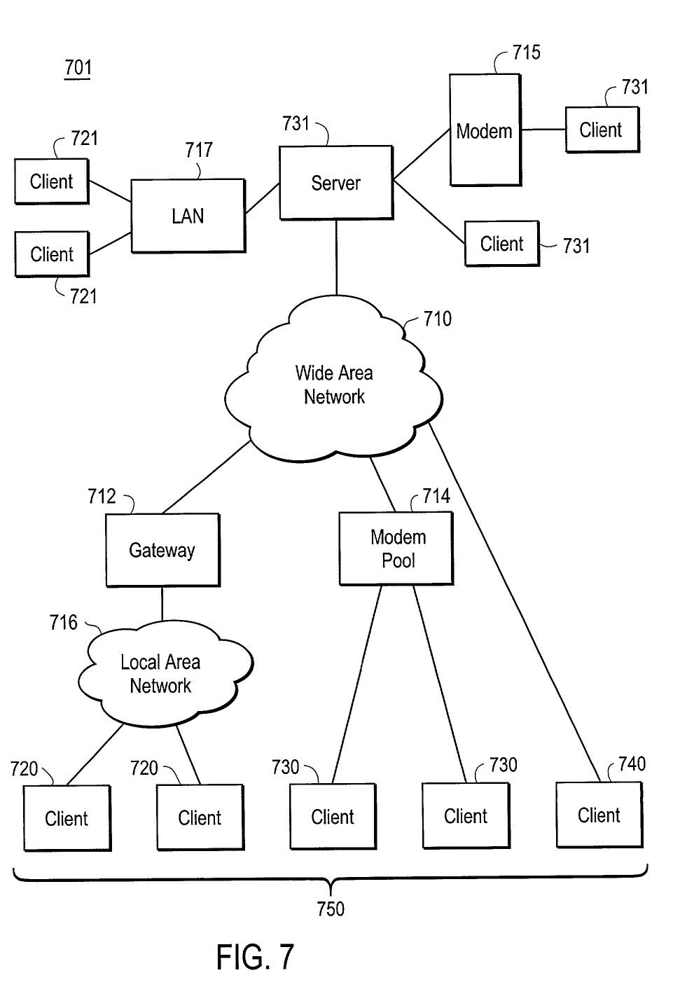

FIG. 7 is a block diagram of one embodiment of a network environment 701 that may be used for communication between clients and servers as described herein. In one embodiment, a server computer system 700 is coupled to a wide-area network 710. Wide-area network 710 may include the Internet or other proprietary networks including, but not limited to, America On-Line™, CompuServe™, Microsoft Network™, and Prodigy ™. Wide-area network 710 may include conventional network backbones, long-haul telephone lines, Internet and/or Intranet service providers, various levels of network routers, and other conventional mechanisms for routing data between computers. Using network protocols, server 700 may communicate through wide-area network 710 to client computer systems 720, 730, 740, which are possibly connected through wide-area network 710 in various ways or directly connected to server 700. For example, client 740 is connected directly to wide-area network 710 through direct or dial up telephone or other network transmission line.

Alternatively, clients 730 may be connected through wide-area network 710 using a modem pool 714. Modem pool 714 allows multiple client systems to connect with a smaller set of modems in modem pool 714 for connection through wide-area network 710. Clients 731 may also be connected directly to server 700 or be coupled to server through modem 715. In another alternative network typology, wide-area network 710 is connected to a gateway computer 712. Gateway computer 712 is used to route data to clients 720 through a local area network 716. In this manner, clients 720 can communicate with each other through local area network (LAN) 716 or with server 700 through gateway 712 and wide-area network 710. Alternatively, LAN 717 may be directly connected to server 700 and clients 721 may be connected through LAN 717.

Using one of a variety of network connection mechanisms, server computer 700 can communicate with client computers 750. In one embodiment, a server computer 700 may operate as a web server if the World-Wide Web (“WWW”) portion of the Internet is used for wide area network 710. Using the HTTP protocol and the HTML coding language, such a web server may communicate across the World-Wide Web with clients 750. In this configuration, clients 750 use a client application program known as a web browser such as the Netscape™ Navigator™, the Internet Explorer™, the user interface of America On-Line™, or the web browser or HTML translator of any other conventional supplier. Using such browsers and the WorldWide Web, clients 750 may access graphical and textual data or video, audio, or tactile data provided by the web server 700.

An Exemplary Computer System

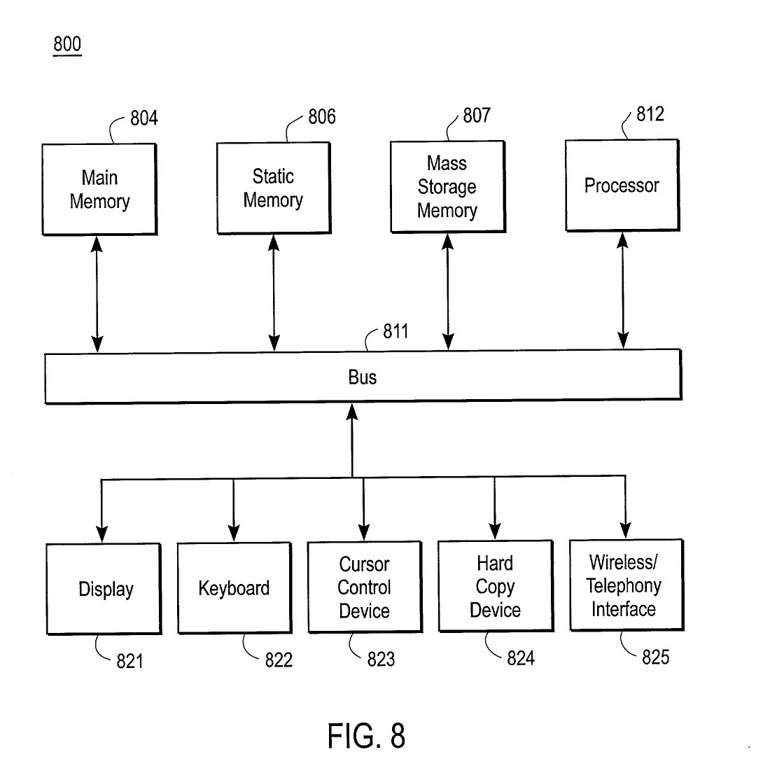

FIG. 8 is a block diagram of an exemplary computer system that may be used to perform one or more operations described herein. Referring to FIG. 8, computer system 800 may comprise an exemplary client 750 or server 700. Computer system 800 comprises a communication mechanism or bus 811 for communicating information, and a processor 812 coupled with bus 811 for processing information. Processor 812 includes a microprocessor, but is not limited to a microprocessor, such as, for example, Pentium™, PowerPC™, Alpha™, etc.

System 800 further comprises a random access memory (RAM), or other dynamic storage device 804 (referred to as main memory) coupled to bus 811 for storing information and instructions to be executed by processor 812. Main memory 804 also may be used for storing temporary variables or other intermediate information during execution of instructions by processor 812.

Computer system 800 also comprises a read only memory (ROM) and/or other static storage device 806 coupled to bus 811 for storing static information and instructions for processor 812, and a data storage device 807, such as a magnetic disk or optical disk and its corresponding disk drive. Data storage device 807 is coupled to bus 811 for storing information and instructions.

Computer system 800 may further be coupled to a display device 821, such as a cathode ray tube (CRT) or liquid crystal display (LCD), coupled to bus 811 for displaying information to a computer user. An alphanumeric input device 822, including alphanumeric and other keys, may also be coupled to bus 811 for communicating information and command selections to processor 812. An additional user input device is cursor control 823, such as a mouse, trackball, trackpad, stylus, or cursor direction keys, coupled to bus 811 for communicating direction information and command selections to processor 812, and for controlling cursor movement on display 821.

Another device that may be coupled to bus 811 is hard copy device 824, which may be used for printing instructions, data, or other information on a medium such as paper, film, or similar types of media. Furthermore, a sound recording and playback device, such as a speaker and/or microphone may optionally be coupled to bus 811 for audio interfacing with computer system 800. Another device that may be coupled to bus 811 is a wired/wireless communication capability 825 to communication to a phone or handheld palm device.

Note that any or all of the components of system 800 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
loading a document into a browser window; and
performing operations to drag-and-drop a digital asset into the document.

2. The method defined in claim 1 wherein the digital asset comprises a sound element.

3. The method defined in claim 1 further comprising selecting an action to trigger digital asset to play.

4. The method defined in claim 3 wherein the action comprises running a cursor over an object in the document.

5. The method defined in claim 3 wherein the action comprises performing a mouse click on an object in the document.

6. The method defined in claim 1 further comprising collecting the digital asset.

7. The method defined in claim 6 further comprising storing the collected digital asset into a bin.

8. The method defined in claim 1 further comprising receiving an address of the document.

9. The method defined in claim 1 further comprising:
sending a modifiable version of the document to a server;
indicating a location in the document at which the digital asset is to be played in response to user navigation;
receiving a new version of the document with a routine inserted therein.

10. The method defined in claim 9 further comprising:
a server application inserting the routine into the modifiable version of the document to create the new version of the document; and
sending the new version of the document to the browser.

11. The method defined in claim 1 further comprising navigating the document using at least one dynamically positioned layered element.

12. The method defined in claim 11 wherein the at least one dynamically positioned layered element comprises one selected from a group comprising a DHTML dynamically positioned layered element or other similarly created dynamically positioned element.

13. The method defined in claim 1 further comprising altering a link within the document so that selection of the link results in a call to a server application.

14. The method defined in claim 1 further comprising splicing at least one routine into the document.

15. The method defined in claim 14 wherein the at least one routine causes the digital asset to be played when triggered by user navigation.

16. The method defined in claim 14 wherein the at least one routine causes a call to a server, causing the server to retrieve the digital asset and send the digital asset to the browser to be played.

17. The method defined in claim 1 wherein performing operations to drag-and-drop the digital asset into the document comprises:
dragging-and-dropping the digital asset to an object on the document, including displaying a dialog box to allow specification of an event to trigger the digital asset to play.

18. The method defined in claim 1 wherein the document comprises a web page.

19. A method for adding one or more sounds to a document, the method comprising:
specifying a sound element to be played during user navigation of the document;
identifying a location in the document to trigger playing the sound element; and
linking the sound element to the document to allow the sound element to be played during user navigation of the document.

20. The method defined in claim 19 further comprising loading the document into a browser window, and wherein linking the sound element to the document comprises performing operations to drag-and-drop a sound element icon into the document.

21. The method defined in claim 19 further comprising selecting an action to trigger the sound element to play.

22. The method defined in claim 21 wherein the action comprises running a cursor over an object in the document.

23. The method defined in claim 21 wherein the action comprises one selected from a group performing a mouse click on an object in the document, performing a keyboard keypress, tabbing to the next field, loading a document, and unloading a document.

24. The method defined in claim 19 further comprising storing the collected sound element into a sound bin.

25. The method defined in claim 19 further comprising specifying the document into which the sound element is to be inserted by entering a document identifier into a dialog box.

26. The method defined in claim 19 further comprising:
sending a modifiable version of the document to a server;
receiving a new version of the document with a routine inserted to cause the sound element to be played in response to user navigation.

27. The method defined in claim 26 further comprising:
a server application inserting the routine into the modifiable version of the document to create the new version of the document; and
sending the new version of the document to a browser.

28. The method defined in claim 19 further comprising navigating the document using at least one dynamically positioned layered element.

29. The method defined in claim 28 wherein the at least one dynamically positioned layered element comprises one selected from a group comprising a DHTML dynamically positioned layered element or other similarly created dynamically positioned element.

30. The method defined in claim 19 further comprising altering a link within the document so that the sound element is played in response to a trigger event.

31. The method defined in claim 30 further comprising the browser making a call to a server requesting delivery of a sound file in response to selection of the link.

32. The method defined in claim 19 further comprising splicing at least one routine into the document.

33. The method defined in claim 32 wherein the at least one routine causes the sound element to be played when trigger by user navigation.

34. The method defined in claim 32 wherein the at least one routine causes a call to a server, causing the server to retrieve the sound element and send the sound element to the browser to be played.

35. The method defined in claim 19 further comprising performing operations to drag-and-drop the sound element into the document by dragging-and-dropping the sound element to an object on the document, including displaying a dialog box to allow specification of an event to trigger the sound element to play.

36. The method defined in claim 19 wherein the document comprises a web page.

37. An apparatus for adding one or more sounds to a document, the apparatus comprising:
means for specifying a sound element to be played during user navigation of the document;
means for identifying a location in the document to trigger playing the sound element; and
means for linking the sound element to the document to allow the sound element to be played during user navigation of the document.

38. The apparatus defined in claim 37 further comprising means for loading the document into a browser window, and wherein the means for linking the sound element to the document comprises means for performing operations to drag-and-drop a sound element into the document.

39. The apparatus defined in claim 37 further comprising means for selecting an action to trigger the sound element to play.

40. The apparatus defined in claim 39 wherein the action comprises running a cursor over an object in the document.

41. The apparatus defined in claim 39 wherein the action comprises performing a mouse click on an object in the document.

42. The apparatus defined in claim 37 further comprising means for storing the collected sound element into a sound bin.

43. The apparatus defined in claim 37 further comprising means for specifying the document into which the sound element is to be inserted by entering a document identifier into a dialog box.

44. The apparatus defined in claim 37 further comprising:
means for sending a modifiable version of the document to a server;
means for receiving a new version of the document with a routine inserted to cause the sound element to be played in response to user navigation.

45. The apparatus defined in claim 44 further comprising a server application to insert the routine into the modifiable version of the document to create the new version of the document and to send the new version of the document to a browser.

46. The apparatus defined in claim 37 further comprising means for navigating the document using at least one dynamically positioned layered element.

47. The apparatus defined in claim 37 further comprising a browser to call to a server requesting delivery of a sound file in response to selection of the link.

48. The apparatus defined in claim 37 further comprising a server application to splice at least one routine into the document.

49. The apparatus defined in claim 48 wherein the at least one routine causes the sound element to be played when trigger by user navigation.

50. The apparatus defined in claim 48 wherein the at least one routine causes a call to a server, causing the server to retrieve the sound element and send the sound element to the browser to be played.

51. The apparatus defined in claim 37 further comprising means for performing operations to drag-and-drop the sound element into the document by dragging-and-dropping the sound element to an object on the document, including displaying a dialog box to allow specification of an event to trigger the sound element to play.

52. The apparatus defined in claim 37 wherein the document comprises a web page.

53. An article of manufacture having at least one recordable medium with executable instructions thereon which when executed by a system cause the system to:
specify a sound element to be played during user navigation of a document;
identify a location in the document to trigger playing the sound element; and
link the sound element to the document to allow the sound element to be played during user navigation of the document.

54. An apparatus comprising:
means for loading a document into a browser window; and
means for performing operations to drag-and-drop a sound element into the document.

55. An article of manufacture having at least on recordable medium with executable instructions thereon which when executed by a system cause the system to:
load a document into a browser window; and
perform operations to drag-and-drop a sound element into the document.
